(19) United States
(12) Patent Application Publication
(10) Pub. No.: US 2004/0212563 A1
(43) Pub. Date: Oct. 28, 2004

(54) Apparatus for efficiently driving plasma display panel performing address-display mixing driving scheme

(75) Inventors: Kyoung-Ho Kang, Suwon-si (KR); Min-Sun Yoo, Cheonan-si (KR); Woo-Joon Jeong, Asan-si (KR); Hakki Choi, Cheonan-si (KR); Seung-Hun Chae, Suwon-si (KR)

Correspondence Address: MCGUIREWOODS, LLP, 1750 TYSONS BLVD, SUITE 1800, MCLEAN, VA, 22102, US

(73) Assignee: Samsung SDI Co., Ltd.

(21) Appl. No.: 10/828,463

(22) Filed: Apr. 21, 2004

(30) Foreign Application Priority Data
Apr. 24, 2003 (KR) 2003-0026003

(51) Int. Cl. G09G 3/28

(52) U.S. Cl. 345/60

(57) ABSTRACT

An apparatus for driving a plasma display panel includes a video processor, a logic controller, an address driver, an X-driver, and a Y-driver. XY-electrode line pairs of the plasma display panel are divided into a plurality of XY-electrode line pair groups. At least one of the X-driver and the Y-driver includes a plurality of driving circuits corresponding to the plurality of XY-electrode line pair groups, respectively. The plurality of driving circuits separately operate so that an addressing and a display-sustain discharge are alternately performed and an alternating current voltage provoking a display-sustain discharge is applied only to XY-electrode line pair groups of which an addressing has been completed.

### BACKGROUND OF THE INVENTION

This application claims the priority of Korean Patent Application No. 2003-26003, filed on Apr. 24, 2003, in the Korean Intellectual Property Office, the disclosure of which is incorporated herein in its entirety by reference.

1. Field of the Invention

The present invention relates to an apparatus for driving a plasma display panel, and more particularly, to an apparatus for driving a surface discharge type triode plasma display panel in which X-electrode lines and Y-electrode lines are alternately arranged in parallel, thereby forming XY-electrode pairs, and display cells are defined in areas where the XY-electrode lines intersect address electrode lines.

2. Description of the Related Art

FIG. 1 shows the structure of a surface discharge type triode plasma display panel. FIG. 2 shows an example of a display cell of the plasma display panel shown in FIG. 1. Referring to FIGS. 1 and 2, address electrode lines A_{R1}, A_{R2}, . . . , A_{Gm}, A_{Bm}, dielectric layers 11 and 15, Y-electrode lines Y₁, . . . , Yₙ, X-electrode lines X₁, . . . , Xₙ, phosphor layers 16, partition walls 17, and a magnesium oxide (MgO) layer 12 as a protective layer are provided between front and rear glass substrates 10 and 13 of a general surface discharge plasma display panel 1.

The address electrode lines A_{R1} through A_{Bm} are formed on the front surface of the rear glass substrate 13 in a predetermined pattern. A rear dielectric layer 15 is formed on the entire surface of the rear glass substrate 13 having the address electrode lines A_{R1} through A_{Bm}. The partition walls 17 are formed on the front surface of the rear dielectric layer 15 to be parallel to the address electrode lines A₁ through Aₘ. These partition walls 17 define the discharge areas of respective display cells and serve to prevent cross talk between display cells. The phosphor layers 16 are formed between partition walls 17.

The X-electrode lines X₁ through Xₙ and the Y-electrode lines Y₁ through Yₙ are formed on the rear surface of the front glass substrate 10 in a predetermined pattern to be orthogonal to the address electrode lines A_{R1} through A_{Bm}. The respective intersections define display cells. Each of the X-electrode lines X₁ through Xₙ is composed of a transparent electrode line Xₙₐ (FIG. 2) formed of a transparent conductive material, e.g., indium tin oxide (ITO), and a metal electrode line X_{nb} (FIG. 2) for increasing conductivity. Each of the Y-electrode lines Y₁ through Yₙ is composed of a transparent electrode line Yₙₐ (FIG. 2) formed of a transparent conductive material, e.g., ITO, and a metal electrode line Y_{nb} (FIG. 2) for increasing conductivity. A front dielectric layer 11 is deposited on the entire rear surface of the front glass substrate 10 having the rear surfaces of the X-electrode lines X₁ through Xₙ and the Y-electrode lines Y₁ through Yₙ. The protective layer 12, e.g., a MgO layer, for protecting the panel 1 against a strong electrical field is deposited on the entire surface of the front dielectric layer 11. A gas for forming plasma is hermetically sealed in a discharge space 14.

A typical driving method for such a plasma display panel has a reset period, an address period, and a display-sustain period sequentially performed in each subfield. In the reset period, charges in all display cells are set to be in a uniform state. In the address period, a predetermined wall voltage is induced in selected display cells. In the display-sustain period, a predetermined alternating current voltage is applied to all of the XY-electrode line pairs so that a display-sustain discharge occurs in the selected display cells in which the predetermined wall voltage was induced in the address period. Accordingly, plasma is formed in the discharge space 14, as a gas layer, of each selected display cell, and ultraviolet rays are emitted. As a result, the phosphor layer 16 is excited, thereby emitting light.

Referring to FIG. 3, a typical driving apparatus for the plasma display panel 1 shown in FIG. 1 includes a video processor 66, a logic controller 62, an address driver 63, an X-driver 64, and a Y-driver 65. The video processor 66 converts an external analog video signal into a digital signal to generate an internal video signal composed of, for example, 8-bit red (R) video data, 8-bit green (G) video data, 8-bit blue (B) video data, a clock signal, a horizontal synchronizing signal, and a vertical synchronizing signal. The logic controller 62 generates drive control signals S_{A}, S_{Y}, and S_{X} in response to the internal video signal from the video processor 66. The address driver 63 processes the address signal S_{A} among the drive control signals S_{A}, S_{Y}, and S_{X} output from the logic controller 62 to generate a display data signal and applies the display data signal to address electrode lines. The X-driver 64 processes the X-drive control signal S_{X} among the drive control signals S_{A}, S_{Y}, and S_{X} output from the logic controller 62 and applies the result of processing to X-electrode lines. The Y-driver 65 processes the Y-drive control signal S_{Y} among the drive control signals S_{A}, S_{Y}, and S_{X} output from the logic controller 62 and applies the result of processing to Y-electrode lines.

An address-display separation driving scheme is used by the plasma display panel 1 having such a structure as disclosed in U.S. Pat. No. 5,541,618, which is hereby incorporated by reference in its entirety. In the address-display separation driving scheme, the address period and the display-sustain period are separated in terms of time domain in each subfield included in a unit frame. Accordingly, during the address period, each XY-electrode line pair is held in standby after being addressed until all of the other XY-electrode line pairs are addressed. Such a standby period makes the wall charge state in each display cell disordered. This decreases the accuracy of display-sustain discharge in the display-sustain period starting from an end point of the address period.

Referring to FIGS. 4 and 5, in the typical driving apparatus using the address-display separation driving scheme as shown in FIG. 3, the X-driver 64 and the Y-driver 65 works together. The X-driver 64 includes a single reset circuit RC_{X} and a single sustain circuit SC_{X}. The Y-driver includes a single reset/sustain circuit RSC and a single scan circuit.

The reset circuit RC_{X} of the X-driver 64 generates driving signals to be applied to all of the X-electrode lines X₁ through Xₙ of the plasma display panel 1 during the reset period. The sustain circuit SC_{X} of the X-driver 64 generates driving signals to be applied to all of the X-electrode lines X₁ through Xₙ during the display-sustain period. A diode D₁ of the X-driver 64 prevents an output of the sustain circuit SC_{X} from influencing an output of the reset circuit RC_{X}.

The reset/sustain circuit RSC generates driving signals O_{RS} to be applied to the Y-electrode lines Y₁ through Y₁ during the reset period and the display-sustain period. The scan circuit of the Y-driver 65 includes a single scan driving circuit AC and a single switching output circuit SIC and sequentially applies scan pluses to Y-electrode lines to perform an addressing operation of generating a predetermined wall voltage in selected display cells. The scan driving circuit AC of the scan circuit generates driving signals to be applied to the Y-electrode lines Y₁ through Yₙ during the address period. The switching output circuit SIC of the scan circuit includes upper transistors YU1 through YUn and lower transistors YL1 through YLn. Common output lines of the respective upper and lower transistor pairs are connected to the Y-electrode lines Y₁ through Yₙ, respectively. Outputs of the reset/sustain circuit RSC and outputs of the scan driving circuit are applied to all of the upper transistors YU1 through YUn and all of the lower transistors YL1 through YLn of the switching output circuit SIC via upper and lower common power lines PL_{U} and PL_{L}.

An operation of the scan circuit including the scan driving circuit AC and the switching output circuit SIC of the Y-driver 65 shown in FIG. 4 will be described with reference to FIG. 5. During the reset period and the display-sustain period, the driving signals O_{RS} generated by the reset/sustain circuit RSC are applied to the Y-electrode lines Y₁ through Yₙ of the plasma display panel 1 via a node A of the scan driving circuit AC and the lower transistors YL1 through YLn of the switching output circuit SIC. In this situation, first through fourth high power transistors S_{SC1}, S_{SC2}, S_{SP}, and S_{SCL} of the scan driving circuit AC are all turned off. The driving signals O_{RS} may be applied to the Y-electrode lines Y₁ through Yₙ of the plasma display panel 1 via the node A of the scan driving circuit AC, the third high power transistor S_{SP}, and the upper transistors YU1 through YUn of the switching output circuit SIC. In this situation, the high power transistors S_{SC1}, S_{SC2}, and S_{SCL} other than the third high power transistor S_{SP} are turned off.

During the address period, the high power transistors S_{SC1}, S_{SC2}, and S_{SCL} other than the third high power transistor S_{SP} of the scan driving circuit AC are turned on. Then, a scan bias voltage V_{SCAN} is applied to the upper transistors YU1 through YUn of the switching output circuit SIC via the first and second high power transistors S_{SC1} and S_{SC2}. In addition, a ground voltage is applied to the lower transistors YL1 through YLn of the switching output circuit SIC via the fourth high power transistor S_{SCL}. Then, a lower transistor connected to a Y-electrode line to be scanned is turned on, and an upper transistor connected to the Y-electrode line to be scanned is turned off. In addition, lower transistors connected to the other Y-electrodes not to be scanned are turned off, and upper transistors connected thereto are turned on. As a result, a scan ground voltage is applied to the Y-electrode line to be scanned, and the scan bias voltage V_{SCAN} is applied to the other Y-electrode lines not to be scanned.

The following describes current paths respectively when the scan ground voltage is applied to the Y-electrode line to be scanned, when the display data signal is applied to the address electrode lines A_{R1} through A_{Bm}, when the application of the display data signal to the address electrode lines A_{R1} through A_{Bm} is terminated, and when the application of the scan ground voltage to the Y-electrode line being scanned is terminated, during the address period.

When the scan ground voltage is applied to the Y-electrode line to be scanned, a current flows from display cells (i.e., electric capacitors) connected to the Y-electrode line to be scanned to a ground terminal via a lower transistor of the switching output circuit SIC and the fourth high power transistor S_{SCL} of the scan driving circuit AC.

When the display data signal is applied to the address electrode lines A_{R1} through A_{Bm}, a discharge current flows from address electrode lines to which a selection voltage is applied to the Y-electrode line which is being scanned, and a current flows to a terminal of the scan bias voltage V_{SCAN} via the other Y-electrode lines which are not being scanned, upper transistors of the switching output circuit SIC, and the first and second high power transistors S_{SC1} and S_{SC2} of the scan driving circuit AC.

When the application of the display data signal to the address electrode lines A_{R1} through A_{Bm} is terminated, a current flows from the terminal of the scan bias voltage V_{SCAN} to the address electrode lines A_{R1} through A_{Bm} via the first and second high power transistors S_{SC1} and S_{SC2} of the scan driving circuit AC, upper transistors of the switching output circuit SIC, and Y-electrode lines.

When the application of the scan ground voltage to the Y-electrode line being scanned is terminated, a current flows from the terminal of the scan bias voltage V_{SCAN} to the display cells via the first and second high power transistors S_{SC1} and S_{SC2} of the scan driving circuit AC, upper transistors of the switching output circuit SIC, and Y-electrode lines.

Accordingly, it can be inferred that a high power transistor for switching needs to be connected between an upper common line of the upper transistors YU1 through YUn of the switching output circuit SIC and the terminal of the scan bias voltage V_{SCAN}. When only a single high power transistor S_{SC1} or S_{SC2} is connected, the following problems occur.

When only the second high power transistor S_{SC2} is connected, during the reset period and the display-sustain period, the driving signals O_{RS} of the reset/sustain circuit RSC are applied to the terminal of the scan bias voltage V_{SCAN} via an internal diode of the second high power transistor S_{SC2}, and thus a current flows. As a result, a driving operation during the reset period and the display-sustain period is instable and requires high power consumption.

When only the first high power transistor S_{SC1} is connected, an unexpected over-shoot pulse of the terminal of the scan bias voltage V_{SCAN} may be applied to all of the upper transistors YU1 through YUn of the switching output circuit SIC via an internal diode of the first high power transistor S_{SC1}. As a result, a driving operation during all of the periods is instable. Consequently, two high power transistors S_{SC1} and S_{SC2} are needed.

In the meantime, when the third high power transistor S_{SP} is not connected and thus the upper common line of the upper transistors YU1 through YUn is merely disconnected with a lower common line of the lower transistors YL1 through YLn, during the reset period and the display-sustain period, the driving signals O_{RS} of the reset/sustain circuit RSC are applied to all of the Y-electrode lines Y₁ through Yₙ via all of the lower transistors YL1 through YLn of the switching output circuit SIC and also applied to the first high power transistor S_{SC1} via internal diodes of the upper transistors YU1 through YUn and an internal diode of the second high power transistor S_{SC2} of the scan driving circuit AC. As a result, the performance and the life span of the first high power transistor S_{SC1} are decreased. However, when the third high power transistor S_{SP} is connected, a voltage is dropped down by a predetermined level by the third high power transistor S_{SP} so that a voltage applied to the first high power transistor S_{SC1} can be decreased.

In such a Y-driver of a typical driving apparatus, even when all of the lower transistors YL1 through YLn of the switching output circuit SIC are turned off, the driving signals O_{RS} of the reset/sustain circuit RSC are applied to all of the Y-electrode lines Y₁ through Yₙ via the lower common power line and the internal diodes of the upper transistors YU1 through YUn.

Accordingly, in a typical address-display separation driving apparatus in which the X-driver 64 and the Y-driver 65 operate integrally, the address period for all of the XY-electrode line pairs must be separated from the display-sustain period in terms of time domain in each subfield included in a unit frame. In this situation, during the address period, each XY-electrode line pair is necessarily held in standby after being addressed until all of the other XY-electrode lines are addressed. Due to an existence of the standby duration after addressing, a state of wall charges in each display cell is disordered. As a result, in the display-sustain period starting from an end point of the address period, accuracy of display-sustain discharge decreases.

### SUMMARY OF THE INVENTION

The present invention provides an apparatus for driving a plasma display panel, which decreases a standby duration between a time when display cells are completely addressed and a time when remaining XY-electrode line pairs are completely addressed and increases the accuracy of display-sustain discharge.

The present invention discloses an apparatus for driving a plasma display panel. The apparatus includes a video processor which converts an external analog video signal into a digital signal to generate an internal video signal, a logic controller which generates drive control signals in response to the internal video signal from the video processor, an address driver which processes an address signal output from the logic controller to generate a display data signal and applies the display data signal to address electrode lines, an X-driver which processes an X-drive control signal output from the logic controller and applies the result of processing to X-electrode lines disposed to cross the address electrode lines, and a Y-driver which processes a Y-drive control signal output from the logic controller and applies the result of processing to Y-electrode lines disposed to parallel with the X-electrode lines so that an X-electrode line and a Y-electrode line forms an XY-electrode line pair. XY-electrode line pairs are divided into a plurality of XY-electrode line pair groups. At least one of the X-driver and the Y-driver comprises a plurality of driving circuits corresponding to the plurality of XY-electrode line pair groups, respectively, and the plurality of driving circuits separately operate so that an addressing and a display-sustain discharge are alternately performed and an alternating current voltage provoking a display-sustain discharge is applied only to XY-electrode line pair groups of which an addressing has been completed.

According to the present invention, addressing and display-sustain discharge are alternately performed by the plurality of driving circuits, and an alternating current voltage provoking a display-sustain discharge is efficiently applied only to XY-electrode line pair groups of which addressing has been completed. Accordingly, a standby time of each XY-electrode line pair group between completion of addressing and beginning of display-sustain discharge is divided, and thus each standby time to each display-sustain discharge. This keeps the charge state of each display cell in order and increases the accuracy of display-sustain discharge.

### BRIEF DESCRIPTION OF THE DRAWINGS

The above and other features and advantages of the present invention will become more apparent by describing in detail preferred embodiments thereof with reference to the attached drawings.

FIG. 1 is a perspective view of the internal structure of a typical surface discharge type triode plasma display panel.

FIG. 2 is a sectional view of an example of a display cell in the plasma display panel shown in FIG. 1.

FIG. 3 is a block diagram of a typical driving apparatus for the plasma display panel shown in FIG. 1.

FIG. 4 is a block diagram showing a Y-driver and an X-driver included in the typical driving apparatus of FIG. 3 using an address-display separation driving scheme.

FIG. 5 is a diagram showing a scan driving circuit and a switching output circuit included in the Y-driver shown in FIG. 4.

FIG. 6 is a block diagram showing a Y-driver and an X-driver included in a driving apparatus according to a first embodiment of the present invention.

FIG. 7 is a block diagram of a scan/sustain circuit shown in FIG. 6.

FIG. 8 is a circuit diagram of a scan circuit included in the scan/sustain circuit shown in FIG. 7.

FIG. 9 is a circuit diagram of a sustain circuit included in the scan/sustain circuit shown in FIG. 7.

FIG. 10 is a circuit diagram of a reset circuit included in the Y-driver shown in FIG. 6.

FIG. 11 is a circuit diagram of the X-driver shown in FIG. 6.

FIG. 12 is a timing chart showing voltage waveforms of driving signals applied to electrode lines in a subfield when address-display mixing driving is performed by the driving apparatus shown in FIG. 6.

FIG. 13A is a cross-section showing a distribution of wall charges in a certain display cell immediately after a gradually increasing voltage is applied to Y-electrode lines during a reset period of FIG. 12.

FIG. 13B is a cross-section showing a distribution of wall charges in a certain display cell at an end point of the reset period of FIG. 12.

FIG. 14 is a block diagram showing a Y-driver and an X-driver included in a driving apparatus according to a second embodiment of the present invention.

FIG. 15 is a timing chart showing voltage waveforms of driving signals applied to electrode lines in a subfield when address-display mixing driving is performed by the driving apparatus shown in FIG. 14.

FIG. 16 is a block diagram showing a Y-driver and an X-driver included in a driving apparatus according to a third embodiment of the present invention.

FIG. 17 is a timing chart showing voltage waveforms of driving signals applied to electrode lines in a subfield when address-display mixing driving is performed by the driving apparatus shown in FIG. 16.

### DETAILED DESCRIPTION OF THE INVENTION

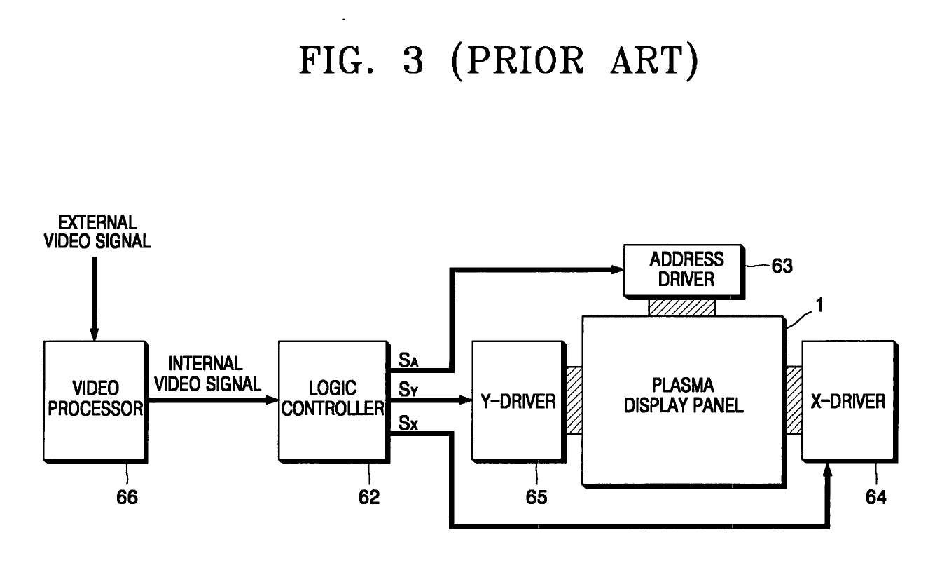

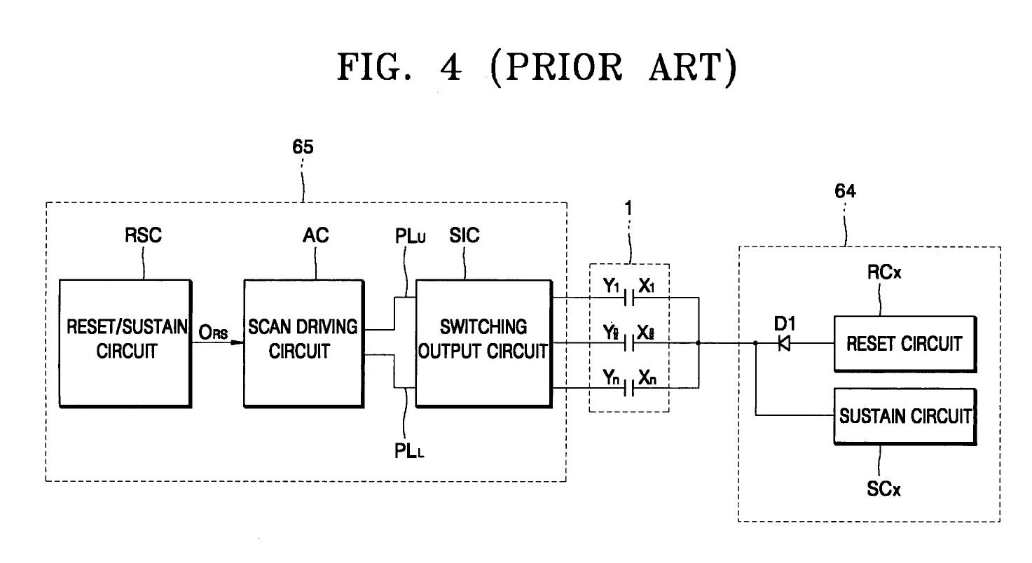

Referring to FIGS. 3, 6, 7 and 8, a driving apparatus according to a first embodiment of the present invention includes a video processor 66, a logic controller 62, an address driver 63, an X-driver 64, and a Y-driver 65. The video processor 66 converts an external analog video signal into a digital signal to generate an internal video signal composed of, for example, 8-bit red (R) video data, 8-bit green (G) video data, 8-bit blue (B) video data, a clock signal, a horizontal synchronizing signal, and a vertical synchronizing signal. The logic controller 62 generates drive control signals S_{A}, S_{Y}, and S_{X} in response to the internal video signal from the video processor 66. The address driver 63 processes the address signal S_{A} among the drive control signals S_{A}, S_{Y}, and S_{X} output from the logic controller 62 to generate a display data signal and applies the display data signal to address electrode lines. The X-driver 64 processes the X-drive control signal S_{X} among the drive control signals S_{A}, S_{Y}, and S_{X} output from the logic controller 62 and applies the result of processing to X-electrode lines. The Y-driver 65 processes the Y-drive control signal S_{Y} among the drive control signals S_{A}, S_{Y}, and S_{X} output from the logic controller 62 and applies the result of processing to Y-electrode lines.

The X-driver 64 includes a single reset circuit RC_{X} and a single sustain circuit SC_{X}. During a reset period, the reset circuit RC_{X} of the X-driver 64 operates together with a reset circuit of the Y-driver 65 and generates driving signals to be applied to all of the X-electrode lines X₁ through Xₙ of the plasma display panel 1. The sustain circuit SC_{X} of the X-driver 64 generates driving signals Ox to be applied to all of the X-electrode lines X₁ through Xₙ during the display-sustain period. A diode D1 of the X-driver 64 prevents an output of the sustain circuit SC_{X} from influencing an output of the reset circuit RC_{X}.

The Y-driver 65 includes a reset circuit RC_{Y}, a first scan/sustain circuit SSC1, and a second scan/sustain circuit SSC2. More specifically, the XY-electrode line pairs of the plasma display panel 1 are divided into first and second XY-electrode line pair groups, and the Y-driver 65 is provided with the first and second scan/sustain circuits SSC1 and SSC2 as driving circuits corresponding to the first and second XY-electrode line pair groups, respectively.

The reset circuit RC_{Y} of the Y-driver 65 operates together with the reset circuit RC_{X} of the X-driver 64 to generate a reset signal O_{R} for making charges in all display cells uniform. The reset signal O_{R} is applied to all of the Y-electrode lines Y₁ through Yₙ via the first and second scan/sustain circuits SSC1 and SSC2.

Each of the first and second scan/sustain circuits SSC1 and SSC2 of the Y-driver 65 includes a sustain circuit SC_{Y} and a scan circuit. The scan circuit sequentially applies scan pulses to Y-electrode lines to perform an addressing operation of generating a predetermined wall voltage in selected display cells. The sustain circuit SC_{Y} simultaneously applies display-sustain pulses to the Y-electrode lines so that display-sustain discharge occurs in the display cells, in which the predetermined wall voltage has been formed, at a predetermined time. An output signal O_{S} of the sustain circuit SC_{Y} of each of the first and second scan/sustain circuits SSC1 and SSC2 and the output signal O_{R} of the reset circuit RC_{Y} are applied to the Y-electrode lines via the scan circuit.

The scan circuit of each of the first and second scan/sustain circuits SSC1 and SSC2 includes a scan driving circuit AC and a switching output circuit SIC and sequentially applies scan pulses to Y-electrode lines to perform an addressing operation of generating a predetermined wall voltage in selected display cells. The switching output circuit SIC includes upper transistors YU₁ through

$$Y {U}_{\frac{n}{2}}$$

and lower transistors YL₁ through

$$Y {L}_{\frac{n}{2}}$$

of an XY-electrode ling pair group corresponding to the switching output circuit SIC, and common output lines of the respective upper and lower transistor pairs are connected to Y-electrode lines Y₁ through

$${Y}_{\frac{n}{2}} ,$$

respectively. During an address period, the scan driving circuit AC generates driving signals to be applied to the Y-electrode lines Y₁ through

$${Y}_{\frac{n}{2}}$$

of the Y-electrode line pair group corresponding to the scan driving circuit AC. In other words, the scan driving circuit AC is connected to the an upper common power line PL_{U} of the upper transistors YU₁ through

$$Y {U}_{\frac{n}{2}}$$

of the switching output circuit SIC and a lower common power line PL_{L} of the lower transistors YL₁ through

$$Y {L}_{\frac{n}{2}}$$

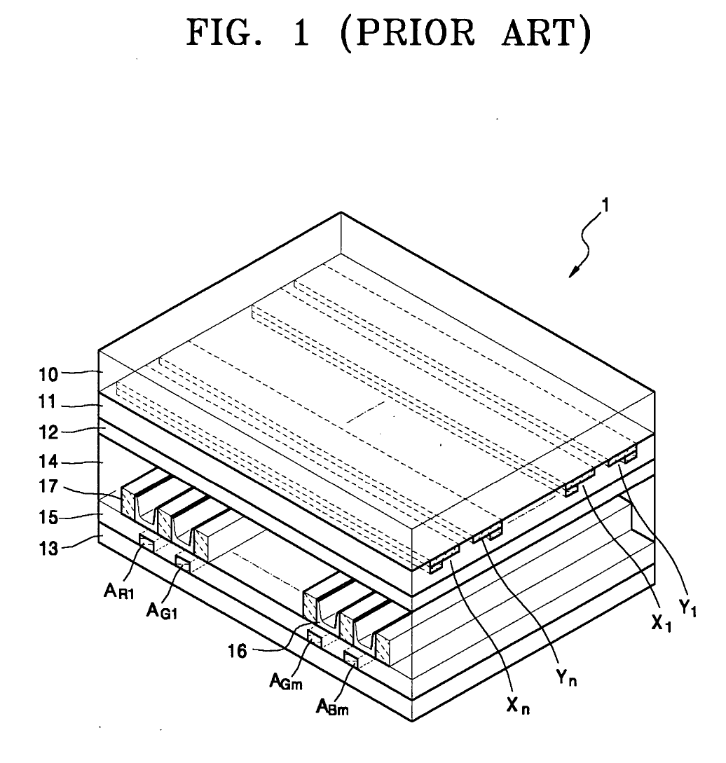

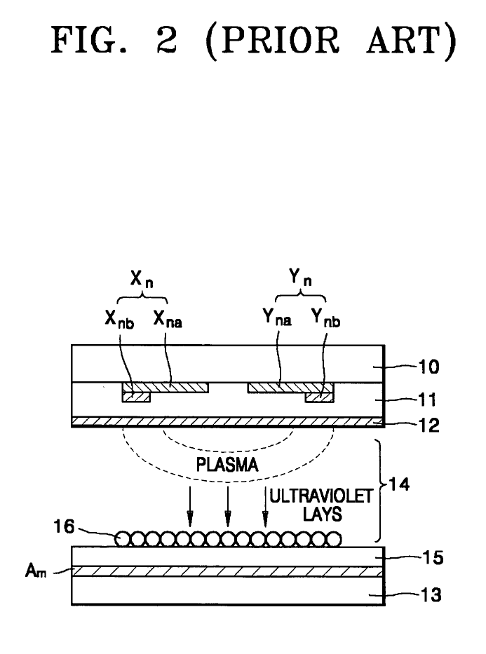

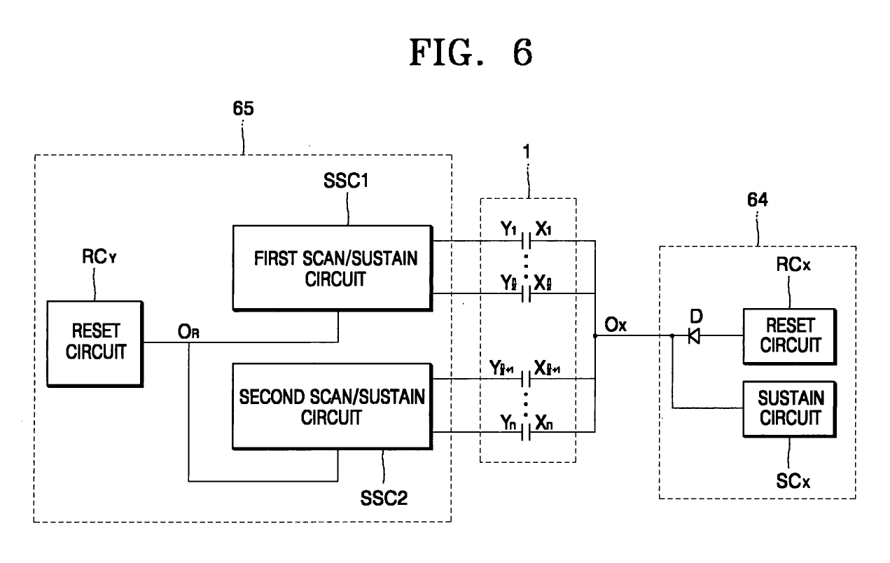

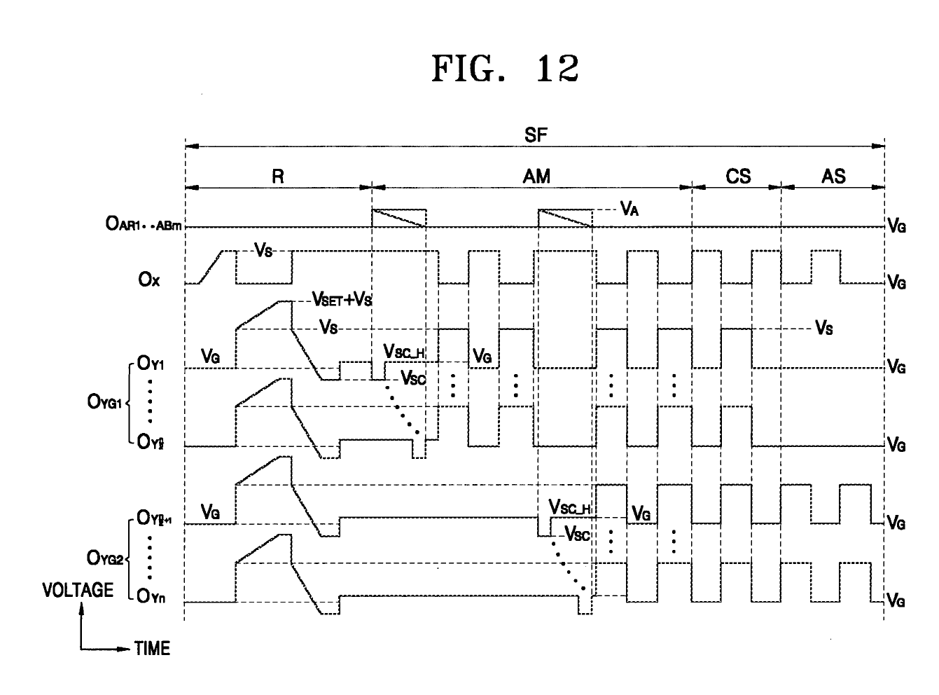

of the switching output circuit SIC, applies a scan voltage to Y-electrode lines, which are scanned during the address period, and applies a scan bias voltage to Y-electrode lines, which are not scanned during the address period. FIG. 12 is a timing chart showing voltage waveforms of driving signals applied to electrode lines in a subfield when address-display mixing driving is performed by the driving apparatus shown in FIG. 6. In FIG. 12, a reference character O_{AR1 . . . ABm} denotes a display data signal applied from the address driver 63 of FIG. 3 to the address electrode lines A_{R1} through A_{Bm} of FIG. 1. A reference character O_{X} denotes a driving signal applied from the X-driver 64 of FIG. 3 to the X-electrode lines X₁ through Xₙ of FIG. 1. A reference character O_{YG1} denotes a driving signal applied from the first scan/sustain circuit SSC1 to the Y-electrode lines Y₁ through

$${Y}_{\frac{n}{2}}$$

of the first XY-electrode line pair group. A reference character O_{YG2} denotes a driving signal applied from the second scan/sustain circuit SSC2 to the Y-electrode lines

$${Y}_{\frac{1}{2} + 1}$$

through Yₙ of the second XY-electrode line pair group. A reference character R denotes a reset period. A reference character AM denotes a mixed period in which an address period and a mixed display-sustain period coexist. A reference character CS denotes a common display-sustain period. A reference character AS denotes a compensation display-sustain period.

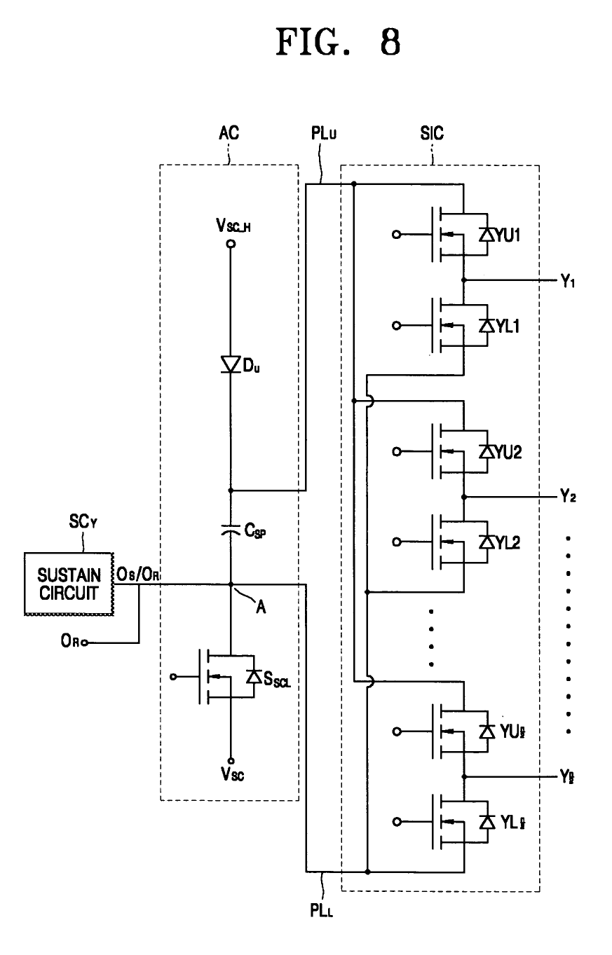

An operation of a scan circuit of any one of the first and second scan/sustain circuits SSC1 and SSC2 will be described with reference to FIGS. 8 and 12.

During the reset period R, the mixed display-sustain period, the common display-sustain period CS, and the compensation display-sustain period AS other than a scan time (i.e., an addressing time), a high power transistor S_{SCL} is turned off, and thus the driving signal O_{S} or O_{R} from the sustain circuit SC_{Y} or the reset circuit RC_{Y} is applied to the lower common power line PL_{L} of the lower transistors YL₁ through

$$Y {L}_{\frac{n}{2}}$$

of the switching output circuit SIC. In addition, the lower transistors YL₁ through

$$Y {L}_{\frac{n}{2}}$$

of the switching output circuit SIC are turned on, and the upper transistors YU₁ through

$$Y {U}_{\frac{n}{2}}$$

are turned off. As a result, the driving signal O_{S} or O_{R} from the sustain circuit SC_{Y} or the reset circuit RC_{Y} is applied to the Y-electrode lines Y₁ through

$${Y}_{\frac{n}{2}}$$

of the first XY-electrode line pair group via the lower transistors YL₁ through

$$Y {L}_{\frac{n}{2}} .$$

During the address period in the mixed period AM, a scan bias voltage V_{SC}_{_{—}}_{H} induced by charging a capacitor C_{SP} is applied to the upper common power line PL_{U} the upper transistors YU₁ through

$$Y {U}_{\frac{1}{2}}$$

of the switching output circuit SIC. In addition, the high power transistor S_{SCL} is turned on. As a result, a negative scan voltage V_{SC} is applied to the lower transistors YL₁ through

$$Y {L}_{\frac{n}{2}}$$

of the switching output circuit SIC via the high power transistor S_{SCL}. Then, a lower transistor connected to a Y-electrode line to be scanned is turned on, and an upper transistor connected to the Y-electrode line to be scanned is turn ed off. In addition, lower transistors connected to all of other Y-electrode lines not to be scanned are turned off, and upper transistors connected to all of the other Y-electrode lines not to be scanned are turned on. Accordingly, the negative scan voltage V_{SC} is applied to the Y-electrode line to be scanned, and the scan bias voltage V_{SC}_{_{—}}_{H} is applied to the other Y-electrode lines not to be scanned.

The following describes current paths respectively when the negative scan voltage V_{SC} is applied to the Y-electrode line to be scanned, when the display data signal is applied to the address electrode lines A_{R1} through A_{Bm} of FIG. 1, when the application of the display data signal to the address electrode lines A_{R1} through A_{Bm} is terminated, and when the application of the negative scan voltage V_{SC} to the Y-electrode line being scanned is terminated, during the address period in the mixed period AM.

When the negative scan voltage V_{SC} is applied to the Y-electrode line to be scanned, a current flows from display cells (i.e., electric capacitors) connected to the Y-electrode line to be scanned to the high power transistor S_{SCL} of the scan driving circuit AC via a lower transistor of the switching output circuit SIC.

When the display data signal is applied to the address electrode lines A_{R1} through A_{Bm}, a discharge current flows from address electrode lines where a selection voltage is applied, to the Y-electrode line which is being scanned. Current flows to the high power transistor S_{SCL} via the other Y-electrode lines which are not being scanned, upper transistors of the switching output circuit SIC, and the capacitor C_{SP} of the scan driving circuit AC.

When the application of the display data signal to the address electrode lines A_{R1} through A_{Bm} is terminated, a current flows from the capacitor C_{SP} of the scan driving circuit AC to the address electrode lines A_{R1} through A_{Bm} via upper transistors of the switching output circuit SIC and the other Y-electrode lines which are not scanned.

When the application of the negative scan voltage V_{SC} to the Y-electrode line being scanned is terminated, a current flows from the capacitor C_{SP} of the scan driving circuit AC to the display cells (i.e., electric capacitors) via upper transistors of the switching output circuit SIC and all of the Y-electrode lines.

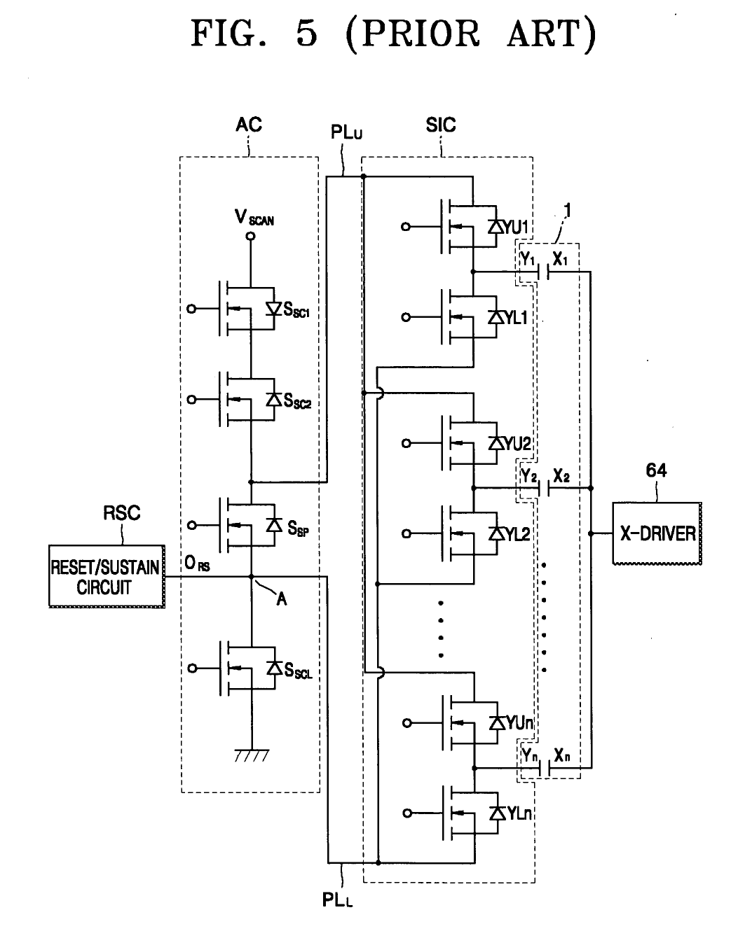

As described above, since a voltage of the capacitor C_{SP} is maintained constant, driving is stable, and a power consumption is not increased. According to the present invention, the scan driving circuit AC can be implemented without using expensive three high power transistors, as compared to the conventional scan driving circuit AC shown in FIG. 5.

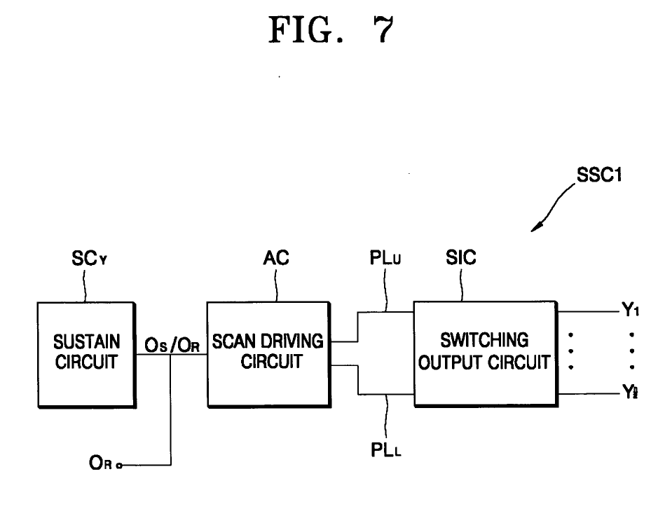

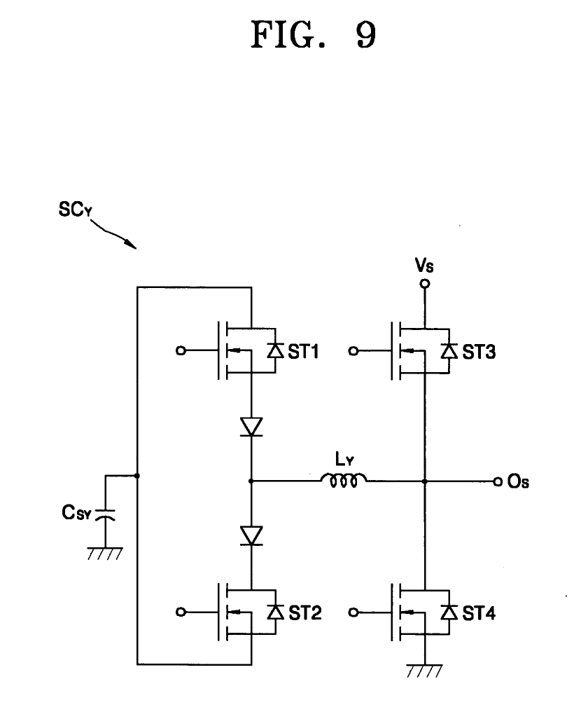

An operation of the sustain circuit SC_{Y} of the first scan/sustain circuit SSC1 of FIG. 7 will be described step by step with reference to FIGS. 9 and 12.

During the mixed display-sustain period in the mixed period AM, during the common display-sustain period CS, and during the compensation display-sustain period AS, while the voltage of pulses applied to the Y-electrode lines Y₁ through

$${Y}_{\frac{n}{2}}$$

of the first XY-electrode line pair group increases from a ground voltage V_{G} to a second voltage V_{S}, only a first transistor STI is turned on. As a result, charges collected in an energy regeneration capacitor C_{SY} is applied to the Y-electrode lines Y₁ through

$${Y}_{\frac{n}{2}}$$

of the first XY-electrode line pair group via inductor L_{Y}.

Next, only the third transistor ST3 is turned on, and thus the second voltage V_{S} as a display-sustain voltage is applied to the Y-electrode lines Y₁ through

$${Y}_{\frac{n}{2}}$$

of the first XY-electrode line pair group.

Next, while the voltage decreases from the second voltage V_{S} to the ground voltage V_{G}, only a second transistor ST2 is turned on. As a result, charges unnecessarily remaining in display cells (i.e., electric capacitors) are collected in the energy regeneration capacitor C_{SY} via the inductor L_{Y}.

Finally, only a fourth transistor ST4 is turned on, and thus the ground voltage V_{G} is applied to the Y-electrode lines Y₁ through

$${Y}_{\frac{n}{2}}$$

of the first XY-electrode line pair group.

The above-described structure and operation of the first scan/sustain circuit SSC1 are the same as those of the second scan/sustain circuit SSC2. However, since the first scan/sustain circuit SSC1 and the second scan/sustain circuit SSC2 independently operate according to the timing chart of FIG. 12, addressing and display-sustain discharge are alternately performed, and an alternating current voltage provoking display-sustain discharge is applied only to an XY-electrode line pair group of which addressing has been completed. According to the first embodiment of the present invention, a standby time of each XY-electrode line pair group from completion of addressing to beginning of display-sustain discharge is divided, and thus each standby time to each display-sustain discharge is shortened so that a charge state in each display cell is not disordered. Consequently, accuracy of display-sustain discharge is increased.

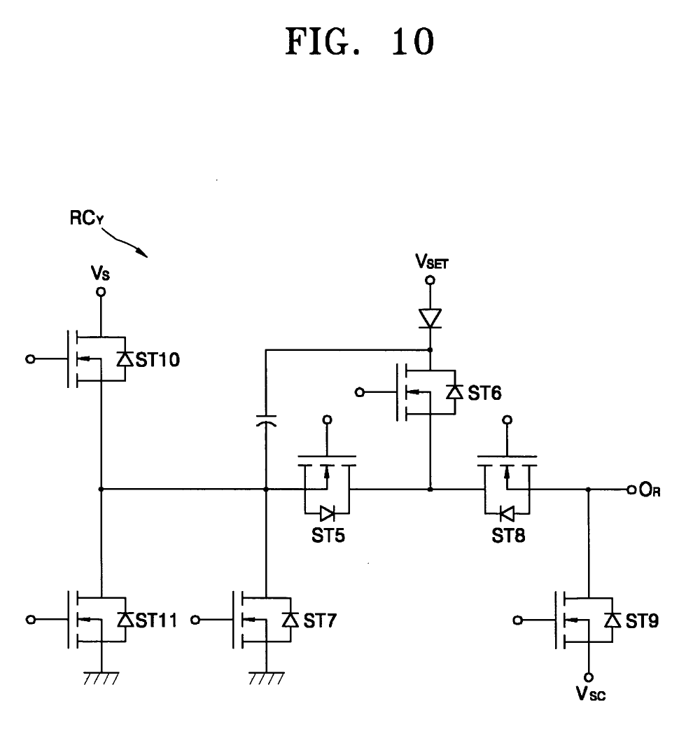

An operation of the reset circuit RC_{Y} of the Y-driver 65 shown in FIG. 6 will be described step by step with reference to FIGS. 10 and 12.

During the reset period R, while a voltage applied to the X-electrode lines X₁ through Xₙ continuously increases from the ground voltage V_{G} to the second voltage V_{S} equal to the display-sustain voltage V_{S}, only eleventh, fifth, and eighth transistors ST11, ST5, and ST8 are turned on. As a result, the ground voltage V_{G} is applied to all of the Y-electrode lines Y₁ through Yₙ.

Next, only tenth, sixth, and eighth transistors ST10, ST6, and ST8 are turned on, and a third voltage V_{SET} is applied to a drain of the sixth transistor ST6. Since a control voltage continuously increasing is applied to a gate of the sixth transistor ST6, a channel resistance value of the sixth transistor ST6 continuously decreases. In addition, since the second voltage V_{S} has been applied to a source of the tenth transistor ST10, due to the effect of a capacitor connected between the source of the tenth transistor ST10 and a drain of the sixth transistor ST6, a voltage continuously increasing from the second voltage V_{S} to a maximum voltage V_{SET}+V_{S} is applied to the drain of the sixth transistor ST6. As a result, the voltage continuously increasing from the second voltage Vs to the maximum voltage V_{SET}+V_{S} is applied to the Y-electrode lines Y₁ through

$${Y}_{\frac{n}{2}}$$

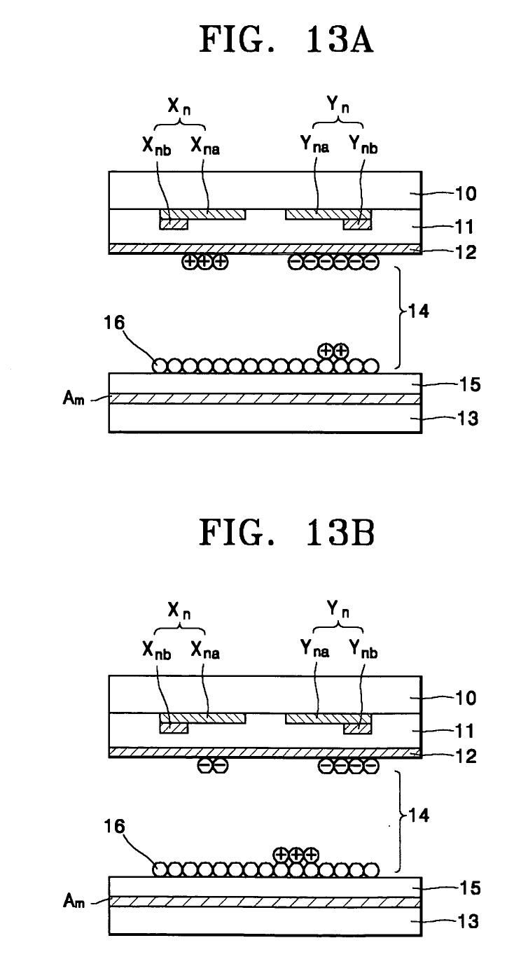

of the first XY-electrode line pair group. Meanwhile, the ground voltage V_{G} is applied to all of the X-electrode lines X₁ through Xₙ, and all of the address electrode lines A_{R1} through A_{Bm}. As a result, a weak discharge occurs between all of the Y-electrode lines Y₁ through Yₙ and the X-electrode lines X₁ through Xₙ, and a weaker discharge occurs between all of the Y-electrode lines Y₁ through Yₙ and the address electrode lines A_{R1} through A_{Bm}. The reason that the discharge occurring between the Y-electrode lines Y₁ through Yₙ and the address electrode lines A_{R1} through A_{Bm} is weaker than the discharge occurring between the Y-electrode lines Y₁ through Yₙ and the X-electrode lines X₁ through Xₙ is because negative wall charges have been formed around the X-electrode lines X₁ through Xₙ. Accordingly, a large amount of negative wall charges are formed around the Y-electrode lines Y₁ through Yₙ, positive wall charges are formed around the X-electrode lines X₁ through Xₙ, and a small amount of positive wall charges are formed around the address electrode lines A_{R1} through A_{Bm} (see FIG. 13A).

Next, only the tenth, fifth, and eighth transistors ST10, ST5, and ST8 are turned on, and the second voltage V_{S} is applied to all of the Y-electrode lines Y₁ through Yₙ.

Next, only the fifth, seventh, eighth, and ninth transistors ST5, ST7, ST8, and ST9 are turned on, and the continuously increasing control voltage is applied to the gates of the respective seventh and ninth transistors ST7 and ST9. As a result, a channel resistance value of the seventh transistor ST7 continuously decreases. Accordingly, the voltage applied to the Y-electrode lines Y₁ through Yₙ continuously decreases from the second voltage Vs to the ground voltage V_{G}. In this situation, the fifth, seventh, and eighth transistors ST5, ST7, and ST8 are turned off, and the voltage applied to the Y-electrode lines Y₁ through Yₙ continuously decreases from the ground voltage V_{G} to a negative voltage V_{SC} equal to a scan voltage. Here, the second voltage V_{S} is applied to all of the X-electrode lines X₁ through Xₙ, and the ground voltage V_{G} is applied to all of the address electrode lines A_{R1} through A_{Bm}. Accordingly, due to a weak discharge between the X-electrode lines X₁ through Xₙ and the Y-electrode lines Y₁ through Yₙ, some of the negative wall charges around all of the Y-electrode lines Y₁ through Yₙ move to all of the X-electrode lines X₁ through Xₙ (see FIG. 13B). The ground voltage V_{G} is applied to all of the address electrode lines A_{R1} through A_{Bm}, and thus the amount of positive wall charges around all of the address electrode lines A_{R1} through A_{Bm} increases a little (see FIG. 13B).

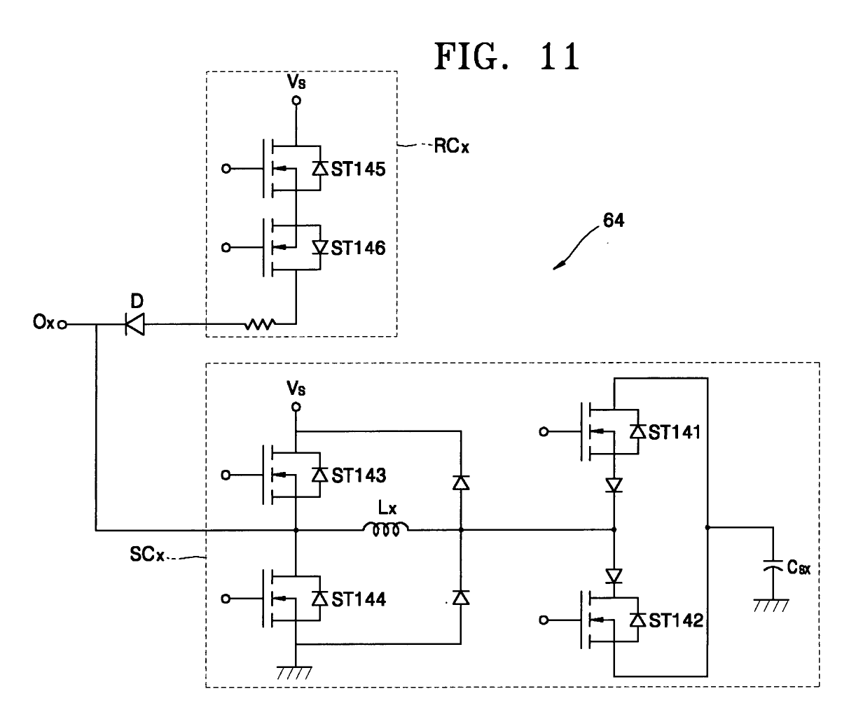

An operation of the X-driver 64 shown in FIG. 6 will be described with reference to FIGS. 11 and 12.

During the reset period R, while the voltage applied to the X-electrode lines X₁ through Xₙ continuously increases from the ground voltage V_{G} to the second voltage V_{S} equal to the display-sustain voltage V_{S}, a control voltage increasing continuously is applied to gates of respective two transistors ST145 and ST146 of the reset circuit RC_{X}, and thus channel resistance values of the respective two transistors ST145 and ST146 decrease continuously. As a result, a voltage of the X driving signal O_{X} continuously increases from the ground voltage V_{G} to the second voltage V_{S} equal to the display-sustain voltage V_{S}. Subsequently, the two transistors ST145 and ST146 of the reset circuit RC_{X} are turned off, and a 144th transistor ST144 of the sustain circuit SC_{X} is turned on. As a result, the ground voltage V_{G} is applied to all of the X-electrode lines X₁ through Xₙ. Thereafter, the 144th transistor ST144 of the sustain circuit SC_{X} is turned off, and the two transistors ST145 and ST146 of the reset circuit RC_{X} are turned on. As a result, the second voltage V_{S} is applied to the X-electrode lines X₁ through Xₙ.

During the mixed display-sustain period in the mixed period AM, during the common display-sustain period CS, and during the compensation display-sustain period AS, while the voltage of pulses applied to the X-electrode lines X₁ through Xₙ increases from the ground voltage V_{G} to the second voltage V_{S}, only a 141st transistor ST141 is turned on. As a result, charges collected in an energy regeneration capacitor C_{SX} is applied to the X-electrode lines X₁ through Xₙ via an inductor L_{X}.

Next, only a 143rd transistor ST143 is turned on, and thus the second voltage V_{S} as a display-sustain voltage is applied to the X-electrode lines X₁ through Xₙ.

Next, while the voltage decreases from the second voltage V_{S} to the ground voltage V_{G}, only a 142nd transistor ST142 is turned on. As a result, charges unnecessarily remaining in display cells (i.e., electric capacitors) are collected in the energy regeneration capacitor C_{SX} via the inductor L_{X}.

Finally, only the 144th transistor ST144 is turned on, and thus the ground voltage V_{G} is applied to the X-electrode lines X₁ through Xₙ.

As shown in FIG. 12, a display-sustain operation of each of the first and second scan/sustain circuits SSC1 and SSC2 is performed indiscriminately. During the mixed display-sustain period in the mixed period AM and during the compensation display-sustain period AS, different display-sustain pulses can be applied to the first and second XY-electrode line pair groups, respectively. Referring to FIG. 12, in a unit subfield SF, a total of 9 display discharges are performed after each of the first and second XY-electrode line pair groups is addressed.

Briefly, addressing and display-sustain discharge are alternately performed, and an alternating current voltage provoking a display-sustain discharge is efficiently applied only to XY-electrode line pair groups of which addressing has been completed. Accordingly, a standby time of each XY-electrode line pair group from completion of addressing to beginning of display-sustain discharge is divided, and thus each standby time to each display-sustain discharge is shortened so that a charge state in each display cell is not disordered. Consequently, accuracy of display-sustain discharge is increased.

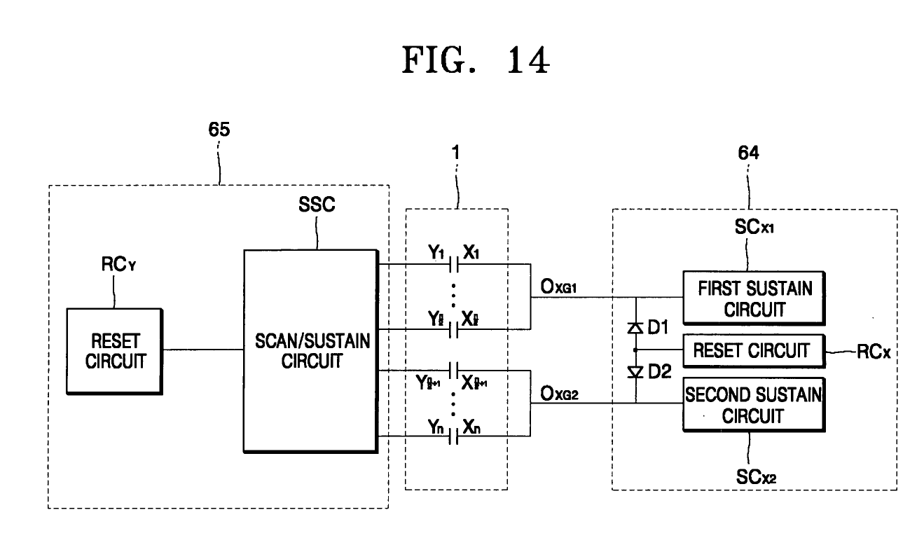

The Y-driver 65 and the X-driver 64 included in a driving apparatus according to a second embodiment of the present invention will be described with reference to FIG. 14. A structure and operation of a reset circuit RC_{Y} of the Y-driver 65 according to the second embodiment are the same as those of the reset circuit RC_{Y} shown in FIGS. 6 and 10 according to the first embodiment. A scan/sustain circuit SSC of the Y-driver 65 according to the second embodiment is different from the first scan/sustain circuit SSC1 shown in FIGS. 6 through 9 according to the first embodiment in that a switching output circuit SIC corresponds to all of the Y-electrode lines Y₁ through Yₙ.

A structure and operation of a reset circuit RC_{X} of the X-driver 64 according to the second embodiment are the same as those of the reset circuit RC_{X} shown in FIGS. 6 and 11 according to the first embodiment. A structure and operation of each of first and second sustain circuits SC_{X1} or SC_{X2} of the X-driver 64 according to the second embodiment are the same as those of the sustain circuit SC_{X} shown in FIGS. 6 and 11 according to the first embodiment.

Accordingly, the second embodiment is different from the first embodiment in that the Y-driver 65 includes a single scan/sustain circuit SSC and the X-driver 64 includes a plurality of sustain circuits SC_{X1} and SC_{X2}. More specifically, the XY-electrode line pairs of the plasma display panel 1 are divided into first and second XY-electrode line pair groups, and the X-driver 64 is provided with the first and second sustain circuits SC_{X1} and SC_{X2} as driving circuits corresponding to the first and second XY-electrode line pair groups, respectively. Diodes D1 and D2 included in the X-driver 64 prevent outputs O_{XG1} and O_{XG2} of the respective sustain circuit SC_{X1} and SC_{X2} from influencing each other via an output terminal of the reset circuit RC_{X}.

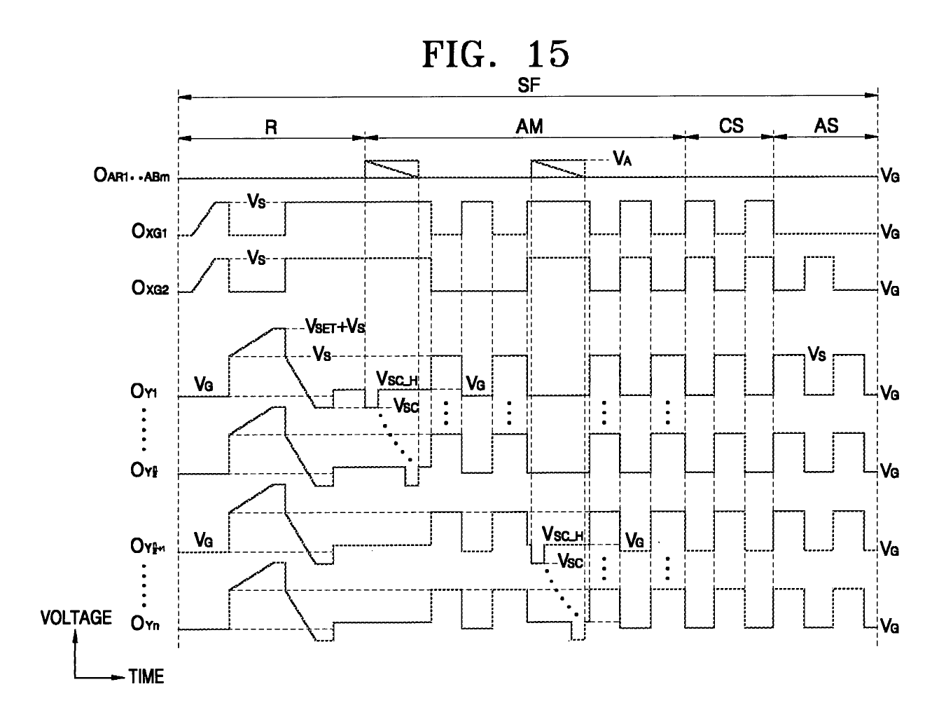

FIG. 15 is a timing chart showing voltage waveforms of driving signals applied to electrode lines in a subfield when address-display mixing driving is performed by the driving apparatus shown in FIG. 14. In FIGS. 12 and 15, the same reference characters denote the same elements. Operations of internal circuits of the driving apparatus according to the timing chart shown in FIG. 15 are the same as those described on the first embodiment.

Referring to FIGS. 14 and 15, a display-sustain operation of each of the scan/sustain circuit SSC of the Y-driver 65 and the first and second sustain circuits SC_{X1} or SC_{X2} of the X-driver is indiscriminately performed. In addition, during the mixed display-sustain period in the mixed period AM and during the compensation display-sustain period AS, different display-sustain pulses can be applied to the first and second XY-electrode line pair groups, respectively.

For example, during a first mixed display-sustain period after an address period for the first XY-electrode line pair group is terminated in the mixed period, the scan/sustain circuit SSC of the Y-driver 65 indiscriminately operates so that two display-sustain pulses are applied to each of the Y-electrode lines Y₁ through Yₙ. In addition, the first sustain circuit SC_{X1} of the X-driver 64 operates indiscriminately together with the scan/sustain circuit SSC of the Y-driver 65 so that a display-sustain pulse is applied to each of the X-electrode lines X₁ through

$${X}_{\frac{n}{2}}$$

of the first XY-electrode line pair group. As a result, during the first mixed display-sustain period, a total of three display-sustain discharges are performed with respect to each XY-electrode line pair of the first XY-electrode line pair group. During the first mixed display sustain period, however, a display-sustain discharge is not performed with respect to the second XY-electrode line pair group because the second sustain circuit SC_{X2} of the X-driver 64 operates indiscriminately so that the ground voltage V_{G} is applied to each of the X-electrode lines

$${X}_{\frac{n}{2} + 1}$$

through Xₙ of the second XY-electrode line pair group and the second XY-electrode line pair group is not addressed.

During the common display-sustain period CS, the first and second sustain circuits SC_{X1} and SC_{X2} of the X-driver 64 apply two display-sustain pulses to each of the X-electrode lines X₁ through Xₙ. In addition, the scan/sustain circuit SSC of the Y-driver 65 operates indiscriminately together with the first and second sustain circuits SC_{X1} and SC_{X2} of the X-driver 64 so that one display-sustain pulse is applied to each of the Y-electrode lines Y₁ through Yₙ. As a result, three display-sustain discharges are performed with respect to each XY-electrode line pair of all XY-electrode line pair groups.

During the compensation display-sustain period AS, the scan/sustain circuit SSC of the Y-driver 65 operates indiscriminately so that two display-sustain pulses are applied to each of the Y-electrode lines Y₁ through Yₙ. In addition, the first sustain circuit SC_{X1} of the X-driver 64 operates indiscriminately so that the ground voltage V_{G} is applied to the X-electrode lines X₁ through

$${X}_{\frac{1}{2}}$$

of the first XY-electrode line pair group. As a result, one display-sustain discharge is performed with respect to each XY-electrode line pair of the first XY-electrode line pair group during the compensation display-sustain period AS. However, the second sustain circuit SC_{X2} of the X-driver 64 operates indiscriminately together with the scan/sustain circuit SSC of the Y-driver 65 so that one display-sustain pulse is applied to each of the X-electrode lines

$${X}_{\frac{n}{2} + 1}$$

through Xₙ of the second XY-electrode line pair group. Accordingly, during the compensation display-sustain period AS, a total of three display-sustain discharges are performed with respect to each XY-electrode line pair of the second XY-electrode line pair group.

Thus, addressing and display-sustain discharge are alternately performed, and an alternating current voltage provoking a display-sustain discharge is efficiently applied only to XY-electrode line pair groups of which addressing has been completed. Accordingly, a standby time of each XY-electrode line pair group from completion of addressing to beginning of display-sustain discharge is divided, and thus each standby time to each display-sustain discharge is shortened so that a charge state in each display cell is not disordered. This increases accuracy of display-sustain discharge.

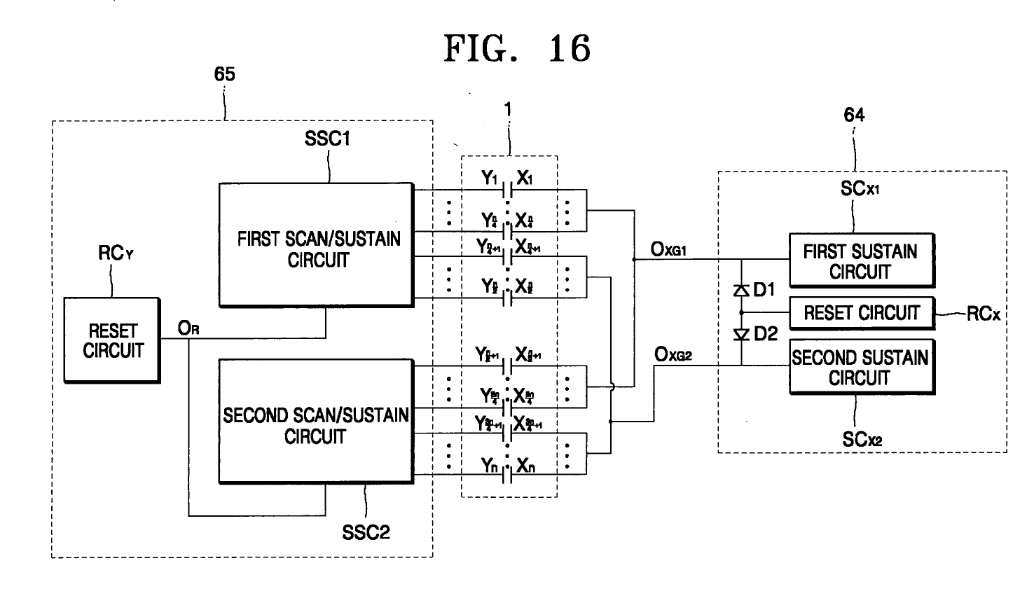

The Y-driver 65 and the X-driver 64 included in a driving apparatus according to a third embodiment of the present invention will be described with reference to FIG. 16. A structure and operation of a reset circuit RC_{Y} of the Y-driver 65 according to the second embodiment are the same as those of the reset circuit RC_{Y} shown in FIGS. 6 and 10 according to the first embodiment. First and second scan/sustain circuit SSC1 and SSC2 of the Y-driver 65 according to the third embodiment have the same structures as those of the Y-driver 65 according to the first embodiment.

A structure and operation of a reset circuit RC_{X} of the X-driver 64 according to the third embodiment are the same as those of the reset circuit RCₓ shown in FIGS. 6 and 11 according to the first embodiment. A structure and operation of each of first and second sustain circuits SC_{X1} or SC_{X2} of the X-driver 64 according to the third embodiment are the same as those of the sustain circuit SC_{X} shown in FIGS. 6 and 11 according to the first embodiment. Diodes D1 and D2 included in the X-driver 64 prevent outputs O_{XG1} and O_{XG2} of the respective sustain circuit SC_{X1} and SC_{X2} from influencing each other via an output terminal of the reset circuit RC_{X}.

The driving apparatus according to the third embodiment of the present invention is designed such that an XY-electrode line pair group including Y-electrode lines driven by one of the first and second scan/sustain circuits SSC1 and SSC2 of the Y-driver 65 is not the same as an XY-electrode line pair group including X-electrode lines driven by one of the first and second sustain circuits SC_{X1} or SC_{X2} of the X-driver 64. More specifically, the XY-electrode line pairs of the plasma display panel 1 are divided into first through fourth XY-electrode line pair groups. The first scan/sustain circuit SSC1 of the Y-driver 65 is assigned to the first and second XY-electrode line pair groups. The second scan/sustain circuit SSC2 of the Y-driver 65 is assigned to the third and fourth XY-electrode line pair groups. The first sustain circuit SC_{X1} of the X-driver 64 is assigned to the odd-numbered first and third XY-electrode line pair groups. The second sustain circuit SC_{X2} of the X-driver 64 is assigned to the even-numbered second and fourth XY-electrode line pair groups.

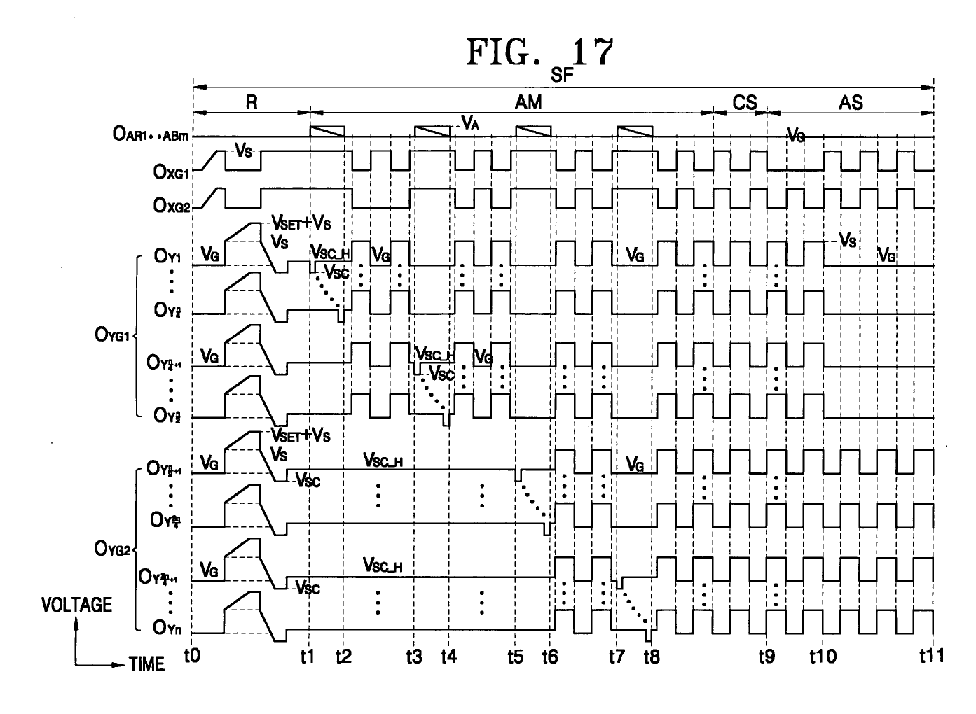

FIG. 17 is a timing chart showing voltage waveforms of driving signals applied to electrode lines in a subfield when address-display mixing driving is performed by the driving apparatus shown in FIG. 16. In FIGS. 12, 15, and 17, the same reference characters denote elements having the same functions. Operations of internal circuits of the driving apparatus according to the timing chart shown in FIG. 17 are the same as those described on the first embodiment.

Referring to FIGS. 16 and 17, the first and second scan/sustain circuits SSC1 and SSC2 of the Y-driver 65 and the first and second sustain circuits SC_{X1} and SC_{X2} of the X-driver 64 can be combined to apply different display-sustain pulses to the first through fourth XY-electrode line pair groups during the mixed display-sustain period in the mixed period AM and during the compensation display-sustain period AS.

For example, during a time from a point t2 to a point t3, the first scan/sustain circuit SSC1 of the Y-driver 65 indiscriminately operates to apply two display-sustain pulses to each of the Y-electrode lines Y₁ through

$${Y}_{\frac{n}{2}}$$

of the first and second XY-electrode line pair groups. Together with the first scan/sustain circuit SSC1 of the Y-driver 65, the first sustain circuit SC_{X1} of the X-driver 64 indiscriminately operates to apply one display-sustain pulse to each of the X-electrode lines X₁ through

$${X}_{\frac{n}{4}}$$

and

$${X}_{\frac{1}{2} + 1}$$

through

$${X}_{\frac{3 n}{4}}$$

of the first and third XY-electrode line pair groups. As a result, during a first mixed display-sustain period in the mixed period AM, a total of three display-sustain discharges are performed with respect to each XY-electrode line pair of the first XY-electrode line pair group. However, the second sustain circuit SC_{X2} of the X-driver 64 indiscriminately operates to apply the ground voltage V_{G} to each of the X-electrode lines

$${X}_{\frac{n}{4} + 1}$$

through

$${X}_{\frac{n}{2}}$$

and

$${X}_{\frac{3 n}{4} + 1}$$

through Xₙ of the second and fourth XY-electrode line pair groups so that the first through fourth XY-electrode line pair groups are not addressed. Consequently, no display-sustain discharges are performed with respect to the second through fourth XY-electrode line pair groups during the time from the point t2 to the point t3 in the mixed period AM.

In the same manner, during a time from a point t4 to a point t5 in the mixed period AM, a display-sustain discharge is performed with respect only to the first and second XY-electrode line pair groups. During a time from a point t6 to a point t7 in the mixed period AM, a display-sustain discharge is performed with respect only to the first through third XY-electrode line pair groups. During a time from a point t8 in the mixed period AM to a point t9 when the common display-sustain period CS ends, a display-sustain discharge is performed with respect to all of the first through fourth XY-electrode line pair groups. During a time from the point t9 to a point t10 in the compensation display-sustain period AS, a display-sustain discharge is performed with respect only to the second and fourth XY-electrode line pair groups. During a time from the point t10 to a point t11 in the compensation display-sustain period AS, a display-sustain discharge is performed with respect only to the third and fourth XY-electrode line pair groups.

As described above, an apparatus for driving a plasma display panel can simultaneously apply different driving signals to different XY-electrode line pair groups during a mixed display-sustain period in a mixed period and during a compensation display-sustain period using a plurality of driving circuits included in an X-driver and/or a Y-driver. In other words, addressing and display-sustain discharge are alternately performed by the plurality of driving circuits included in the X-driver and/or the Y-driver, and an alternating current voltage provoking a display-sustain discharge is efficiently applied only to XY-electrode line pair groups of which addressing has been completed. Accordingly, a standby time of each XY-electrode line pair group from completion of addressing to beginning of display-sustain discharge is divided, and thus each standby time to each display-sustain discharge is shortened so that a charge state in each display cell is not disordered. Consequently, accuracy of display-sustain discharge is increased.

Although a few embodiments of the present invention have been shown and described, it will be appreciated by those skilled in the art that changes may be made in these elements without departing from the principles and spirit of the invention, the scope of which is defined in the appended claims and their equivalents.

What is claimed is:

1. A driver for driving a plasma display panel, wherein the plasma display panel includes a plurality of address electrode, a plurality of X electrode and a plurality of Y electrode, said driver comprising:
an address driver;
an X driver; and
a Y driver,
wherein the plurality of X electrodes and the plurality of Y electrodes are arranged alternately next to each other forming a XY electrode pair group and in substantially perpendicular to the to the plurality of address electrode,
wherein the XY electrode pairs are divided into a plurality of XY electrode pair groups, and
wherein at least one of the X driver and the Y driver comprises a plurality of driving circuits corresponding to the plurality of XY electrode pair groups.

2. The driver of claim 1, wherein the plurality of driving circuits operate independently to perform an addressing operation and a display sustain discharge operation alternately and to apply a voltage for display-sustain discharge only to an XY electrode pair group that has already been addressed.

3. The driver of claim 1, wherein each of the plurality of driving circuits of the Y driver comprises:
a scan circuit that sequentially applies a scan pulse to the plurality of Y electrodes for addressing; and
a sustain circuit that simultaneously applies periodical display-sustain pulses of the alternating current voltage to the plurality of Y electrodes.

4. The driver of claim 3, wherein the scan circuit comprises:
a switching output current; and
a scan driving circuit.

5. The driver of claim 4, wherein the switching output circuit comprises:
an upper transistor;
a lower transistor; and
a common output line for the upper transistor and the lower transistor,
wherein the common output line is coupled to one of the plurality of Y electrode.

6. The driver of claim 5, wherein the scan circuit is coupled to an upper common power line of the upper transistor and to a lower common power line of the lower transistor to apply a scan voltage to one of the plurality of Y electrode that is scanned during an addressing period and to apply a scan bias voltage to one of the plurality of Y electrode that is not scanned during the addressing period.

7. The driver of claim 6, wherein an output of the sustain circuit is applied to one of the upper common power line and the lower common power line via the scan driving circuit.

8. The driver of claim 3, wherein the Y driver further comprises a single reset circuit that performs a reset operation for having a state of charges in every display cell uniform.

9. The driver of claim 8, wherein the X driver comprises a single reset circuit that operates together with the reset circuit of the Y driver.

10. The driver of claim 8, wherein each of the plurality of driving circuits of the X driver comprises a sustain circuit which simultaneously applies periodical display-sustain pulses of the alternating current voltage to the X electrode lines.

11. The driver of claim 2, wherein each of the plurality of driving circuits of the Y driver drives Y electrodes of a corresponding XY electrode pair group, each of the plurality of driving circuits of the X driver drives X electrodes of a corresponding XY electrode pair group, wherein an XY electrode pair group including the plurality of Y electrodes driven by one among the plurality of driving circuits of the Y driver is not the same as an XY electrode pair group including the plurality of the X electrodes driven by one among the plurality of driving circuits of the X driver.

12. A plasma display panel device, comprising:
a plasma display panel;
a video processor;
a logic controller;
an X driver that controls a plurality of X electrodes;
a Y driver that controls a plurality of Y electrodes; and
an address driver that controls a plurality of address electrodes,
wherein the plurality of Y electrodes and the plurality of X electrodes are arranged alternately next to each other forming XY electrode pairs,
wherein the XY electrode pairs are divided into a plurality of XY electrode pair groups, and
at least one of the X driver and the Y driver comprises a plurality of driving circuits corresponding to the plurality of XY electrode pair groups.
